(19) United States
(12) Patent Application Publication
(10) Pub. No.: US 2003/0119533 A1
(43) Pub. Date: Jun. 26, 2003

(54) Multicast location management in a universal terrestrial radio access network

(76) Inventors: Sinikka Sarkkinen, Kangasala (FI); Jari Isokangas, Tampere (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/304,056

(22) Filed: Nov. 26, 2002

Related U.S. Application Data
(60) Provisional application No. 60/332,506, filed on Nov. 26, 2001.

(51) Int. Cl. H04B 7/00

(52) U.S. Cl. 455/500

(57) ABSTRACT

A method and apparatus for keeping track of User equipment (UE) locations without regard to an existing Radio Resource Controller (RRC) connection for multicast services in a Routing Area Network (RAN). The invention includes performing a multicast area update procedure in the RRC whether the UE has an existing RRC connection or not. The performing step includes sending from the UE a MULTICAST AREA UPDATE message when the UE detects whether a multicast area change has occurred.

This application claims the benefit of the priority of U.S. Provisional Patent Application No. 60/332,506 filed on Nov. 26, 2001, which provisional application is hereby incorporated by reference in its entirety.

### BACKGROUND OF THE INVENTION

1. Field of the Invention

The present invention is related to a method and apparatus for performing multicast services in a network. More particularly the present invention is related to a method and apparatus for keeping track of User equipment (UE) locations without regard to an existing Radio Resource Controller (RRC) connection for multicast services in a Routing Area Network (RAN).

2. Discussion of the Related Art

The effort to standardize Multicast as a new service started in the 3^{rd} Generation Partnership Project (3GPP). The aim in this effort is to enhance the current capabilities in an Universal Terrestrial Radio Access Network (UTRAN) and also in a Core Network (CN) to make them capable of providing such services. These services use the common network resources, but are intended only to be provided to a restricted group of people in a cell. These requirements are not totally fulfilled in current Cell Broadcast concept, which was standardised in Release 99 of the 3GPP specifications.

Basically the standardization of the multicast type of service means that the new service concept should be capable of transmitting data simultaneously to a group of people, who previously indicated their interest to receive data belonging into Multicast service.

In one cell the multicast related data is intended to be sent at the same time to all subscribers by using a single physical channel on the radio interface. In an UTRAN this channel can be e.g. SCCPCH, which is currently used to transmit data from common channels and from the FACH, which is devoted for the cell broadcast services.

In order to use the radio interface more efficiently, before sending any multicast data through the air interface, the network should know more precisely the location of the authorized User Equipment (UE) i.e. whether there are any UEs in any cell upon activation of the multicast data transmission. Currently the fetching of this kind of information from a Radio Network Controller (RNC) is possible only if the RNC is aware of Internal Mobile Subscriber Identifier (IMSI) of the UEs (i.e. UEs, which has the multicast service description) and the UE is in Radio Resource Controller (RRC) connected state. However it is more than likely that the most of the UEs are in IDLE mode, which means that UE has no RRC connection at the UTRAN and therefore UE is unknown in the UTRAN. Therefore the location of the UE is known only in the CN side, and there the location of the UE can be defined on Location/Routing area level. Based on this information the efficient scheduling decision of the multicast data cannot be made in the UTRAN and therefore it is always possible that the RNC sends multicast data into cells where no authorized UEs exist.

Thus, there is a need for a system or apparatus for allowing the RNC to keep a record of the location of the UEs in the cells even though they are in the IDLE mode.

### BRIEF SUMMARY OF THE INVENTION

The present invention provides a method and apparatus for keeping track of User equipment (UE) locations without regard to an existing Radio Resource Controller (RRC) connection for multicast services in a Routing Area Network (RAN). The invention includes performing a multicast area update procedure in the RRC whether the UE has an existing RRC connection or not. The performing step includes sending from the UE a MULTICAST AREA UPDATE message when the UE detects whether a multicast area change has occurred.

The invention keeps track of UE locations with/without an existing RRC connection for multicast services in a Routing Area Network (RAN). For this purpose the new database (Multicast location database—MuLD) in each multicast capable RNC is introduced to store the multicast status information. The management (e.g. updating) of the MuLD is independent of the UE state. The multicast area update procedure can take place whether the UE has an existing RRC connection or not.

The invention is intended to operate such as when an UE is in the idle mode and it has only MM context in CN side, and no cell changes are reported to the UTRAN. In practice this means that the location of the UE in this state can be verified on the location area or the Routing area level. One location area and routing area may include a number of RNCs and its coverage area, which means that the location of the UE and the number of authorized UEs in specific cells is unknown. To overcome this problem a new multicast area update procedure in a Radio Resource Controller (RRC), without RRC connection, is introduced. The UE shall send a MULTICAST AREA UPDATE message when it detects the cell/multicast area change, with certain limitations. This procedure can be performed with respect to the UTRAN without establishing the RRC connection first. However, if the UE already has the RRC connection the multicast area related information is included in the existing RRC messages.

To provide the CN with a method to request the multicast status information from a Routing Area Network (RAN), a new procedure and messages are introduced in Routing Area Network Application Part (RANA P). With this procedure the CN may request multicast group/service and/or multicast subscriber information from RAN. To keep the MuLD updated, such as when the UE moves from one Multicast area to another Multicast area, new messages/IEs are introduced in RANAP and Radio Network System Application Part (RNSAP). By implementing the invention the following advantages are derived:

Based on the solution provided by the invention the RNC is aware of the number of UEs in the cell, that are allowed to receive multicast data of certain multicast service or multicast group.

Based on this information provided by the invention the RNC can define, in which cell the multicast data is required to send.

The invention saves resources on air interface in such cell where no multicast data is required to be transmitted due to the lack of multicast subscribers.

Although the invention may have one disadvantage in which depending on the priority of the service subscription the UE may have to make additional updates to the network. This disadvantage is out weighed by above described advantages.

### BRIEF DESCRIPTION OF THE DRAWINGS

FIG. 1 illustrates the states of the UE (and RRC connection);

FIG. 2 illustrates an example of the signalling flow for the deletion of the location information from the old RNC caused by the entering into a new Multicast area;

FIG. 3 illustrates an example of the signalling flow for the deletion of the location information from the old RNC caused by the entering into a Location/ Routing area;

FIG. 4 illustrates required modifications in CELL UPDATE message;

FIG. 5 illustrates required modifications in UTRAN Registration Area (URA) UPDATE message;

FIG. 6 illustrates the structure of the new MULTICAST AREA UPDATE message;

FIG. 7 illustrates required modifications in UPLINK DIRECT TRANSFER message;

FIG. 8 illustrates required modifications in DIRECT TRANSFER message;

FIG. 9 illustrates the structure of the new MULTICAST SUBSCRIBER UPDATE message on RANAP;

FIG. 10 illustrates the structure of the new MULTICAST STATUS REQUEST message on RANAP;

FIG. 11 illustrates the structure of the new MULTICAST STATUS RESPONSE message on RANAP; and

FIG. 12 illustrates the structure of the new MULTICAST SUBSCRIBER UPDATE message on RNSAP.

### DETAILED DESCRIPTION OF THE INVENTION

In order to allow the UTRAN to support recording of the location of the UEs, which are authorized to receive multicast related data, some definitions need to be made.

Multicast Area (MuA)

The new Multicast Area (MuA) corresponds to an area similar to that currently defined for the Cell Broadcast services (3GPP; TS 23.003). However, in the case of MuA, the largest area, which can be named with one identification, can be equal or smaller to the coverage area of one RNC. The multicast area indication can be transmitted to the UE with the aid of system broadcast signalling messages (BCH: SIB signalling messages).

Multicast Area Update

The MULTICAST AREA UPDATE procedure is performed by the UE, when UE enters in the new Multicast Area. For this purpose it is possible to define either a new RRC signalling message or UE can use already defined RRC messages, which are updated with required information fields. These kind of RRC messages could be for example cell update/URA update messages.

MULTICAST AREA Update Message

This message is used to transmit multicast related information upon IDLE and URA_PCH state. The size of this message cannot exceed the maximum size of the one PRACH radio frame.

Multicast Location Database (MuLD)

The Multicast location database (MuLD) is used to store the information about the location of the multicast authorized UEs. The database is composed of UE related records, which may consist of the following fields: MuUE-id (see later), Multicast Group id or/and Multicast Service Id, location (see: table 2 below).

TABLE 2
example of the multicast record content

| Mu UE -id | Group/Service id | Location id |
|---|---|---|
| Xxxx xxxy | Xxxx xxxk | Yyyy |
| Xxxx xxxy | Xxxx xxxn | Yyyy |
| Xxxx xxx2 | Xxxx xxxk | Zzzz |
| Xxxx xxx2 | Xxxx xxxn | Xxxx |
| Xxxx xxx3 | Xxxx xxxn | Xxxx |

From the example record in Table 2, the UEs which are authorized to receive multicast data are dispersed under three different e.g. cells. In area “yyyy” there are two UEs, which are not allowed to receive the same multicast data service, whereas in area “xxxx” both UEs are the subscribers of the same service. Also from the table it is possible to see that multicast service identified with “Xxxx xxxn ” must be sent through areas “yyyy” and “xxxx”, but not via “zzzz”.

Multicast UE-id

Multicast UE-id in Multicast record is required to identify the UE in a way that e.g. the updating and the cleaning of the record can be made based on UEs' identification. The used UE-id can be e.g. TMSI or it can be a new identification, which consists of Service id (or/and group id) and multicast subscriber ID (see: tables 1a and b below). The basic idea is that Service Id (or/and group id) and multicast subscriber Id should build up together a unique identification, which is given to the subscriber upon multicast subscription or registration phase.

Tables 1a and b: Examples of the model how Multicast UE-id can be generated between different Services/multicast groups.

TABLE a
SERVICE/GROUP N

| Service/Group Id | Subscriber id |
|---|---|
| Xxxx xxxn | Xxxx xxx1 |
| Xxxx xxxn | Xxxx xxx2 |
| . . . | |
| Xxxx xxxn | Xxxx xxxM |

TABLE b
SERVICE/GROUP K

| Service/Group Id | Subscriber id |
|---|---|
| Xxxx xxxk | Xxxx xxx1 |
| Xxxx xxxk | Xxxx xxx2 |
| . . . | |
| Xxxx xxxk | Xxxx xxxy |

Multicast Service Subscription Priority

The multicast service subscription priority identifies the priority of the multicast service on level that, which services are more “critical” to receive and which are less important.

Preferred Embodiment

The preferred embodiment is based on an assumption that UEs are at least attached to the network, namely the UEs are not in a dead state and have MM context at the CN side. UEs are in a dead state when, e.g., the power of the UE is turned off or when the UE has not indicated its presence to the network by performing the IMSI/GPRS Attachment, in order to establish an MM context to the core network.

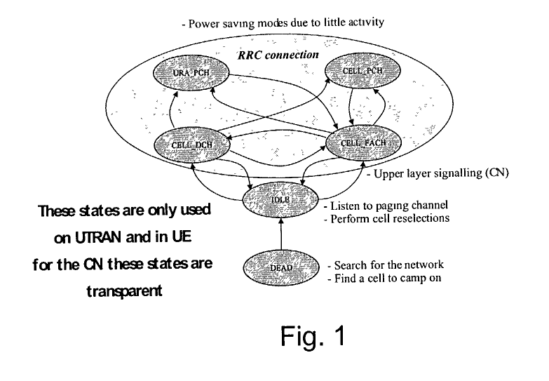

The UEs can be in IDLE mode from RRC point of view as shown in FIG. 1. If the UE has RRC connection, then the mode of the UE can be either cell_DCH, cell_FACH, cell_PCH or URA_PCH. Another assumption is that the UE is aware of the multicast subscription, specifically the UE is configured to receive multicast related data. The UE has information about multicast services on which it is entitled, multicast area, priority of the subscription, etc.

1. UE in Idle Mode

In idle mode, the UE has the MM context in the core network side, and therefore the network is aware of the UE in the PLMN. However, no resources are reserved for the UE from the UTRAN side.

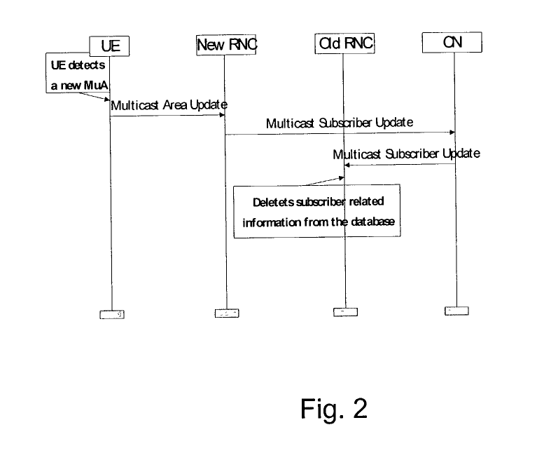

The UEs, which are in idle mode, monitor the cell information from the BCH. As soon as the RNC detects that the UE enters into a new cell, and the UE is configured to receive multicast data, the UE checks the priority of the multicast service subscription. If this priority indicates the highest priority the UE sends to the network either a new Multicast location update message or it can use the currently defined RRC. A Cell Update message is sent to update support multicast related information. If the subscription of the multicast service is not “critical”, then the performance of the Multicast location update is not mandatory as per FIG. 2.

If the UE detects that it has entered into a new Multicast area, the UE performs the Multicast location update without checking the priority of the multicast service subscription.

If UE detects that it has also entered into a new location area/Routing area, the UE sends instead of the Multicast location update message the normal MM: LOCATION AREA/ROUTING AREA UPDATE message to the network by using RRC: UPLINK DIRECT TRANSFER (DTAP) message structure. This DTAP message can be updated to carry also multicast related information, which is terminated in RNC.

2. UE in RRC Connected Mode

When UE is in a RRC connected mode and has a RRC connection from the UTRAN side (i.e., is known by the UTRAN), the state of the RRC can be either cell_DCH, cell_FACH, cell_PCH or URA_PCH. See FIG. 1. On the cell_DCH, cell_FACH and cell_PCH states, the UE's location is known on the cell level already and it will be updated based on providing a soft handover (cell_DCH) and cell update procedures. Currently upon cell URA_PCH state the location of the UE is known in the RNC on URA level, which includes more than one cell.

2.1 Cell_DCH, Cell_FACH, Cell_PCH States

When UE enters into a new cell in cell_DCH state (i.e. soft handover is activated or UE performs hard handover etc) the multicast related information is updated in RNC without indication from UE.

When UE enters into a new cell in cell_FACH or cell_PCH state, the UE can send either the MULTICAST AREA UPDATE message or cell update message, which has been updated to carry also multicast related information. It is not required to check the priority of the service subscription.

2.2. Cell_URA_PCH State

In the cell URA_PCH state, when the UE enters into a new cell, the UE checks the priority of the multicast service subscription. If the priority indicates “critical ” priority, then the UE sends the MULTICAST AREA UPDATE message to the network. If the configured priority is low, then no messages will be sent to the network.

If the UE in cell_URA_PCH state enters into a new URA area, the UE sends a RRC: URA UPDATE message to the network, which is updated with multicast related information.

3. The Required Information from UE

When the UE sends either MM: LOCATION UPDATE/ROUTING AREA UPDATE message, RRC: CELL UPDATE, RRC: URA UPDATE or RRC: MULTICAST AREA UPDATE message the UE needs to send to the network at least the following information:

service id or/and group id

Mu UE—id (see Mu UE—id definition)

cause: UE has entered into a new multicast area

old multicast area id

Note: cell information can be identified from the used logical channel (e.g. CCCH)

4. Transmission of the Multicast Related Information

Multicast related information can be sent either by using a new MULTICAST AREA UPDATE message or by using already defined RRC messages (like UPLINK DIRECT TRANSFER, CELL UPDATE, URA UPDATE etc.) From the UE these messages can be sent by using PRACH physical channel on air interface and RACH transport channel in UTRAN.

In IDLE mode (and also upon URA_PCH state) the sending of the MULTICAST AREA UPDATE message does not trigger the establishment of the RRC connection for the UE. Preferably, the logical channel used for transmission of this message is CCCH.

On IDLE mode and upon URA-PCH state when UE uses the MULTICAST AREA UPDATE message the timing to send this message can be defined to not be a critical transaction, i.e. it is not critical if the message is not immediately sent to the network after the UE has camped into a new cell. The MULTICAST AREA UPDATE message is meant to send only once (or twice) and no acknowledgement is expected from the network side.

5. The Required Transaction at the UTRAN Side

When RNC receives multicast related information either in UPLINK DIRECT TRANSFER, CELL UPDATE, URA UPDATE etc or in MULTICAST AREA UPDATE message, it checks the identification of the UE from the Mu UE-id field, and if UE sees that this UE has enter from one cell to another under same RNC the location field in the record is updated accordingly. If RNC sees that no UE can be found with this identification a new record is generated.

Based on the generated records the RNC is aware of approximate number of the UEs in each cell. And based on this information the RNC can schedule multicast related information into correct cells.

6. Cleaning of the Old Information from the Multicast Database in Old RNC

The cleaning of the database is performed with the aid of the CN or directly through the lur interface. In a case when the location area/routing area is large than one RNC coverage area, the updating of the multicast database is triggered when the UE detects the new multicast area (see definition). In that case the UE sends the MULTICAST AREA UPDATE message, in where UE has include the cause field (i.e. message is sent because the multicast is changed) and old multicast area id. When a new RNC receives this message the RNC generates RANAP(/RNSAP): Multicast subscriber update message, in where RNC requests CN to inform the old RNC about the made multicast area update procedure (or if message is sent through RNSAP, the new RNC requests the old RNC to delete corresponding records from old RNC's database). When CN receives this message (with old multicast area information) the CN sends RANAP(/RNSAP): Multicast subscriber update message to the old RNC, which deletes the invalid records from the database accordingly. (the deletion will base on the value of Mu UE—id field) The proposed procedure via CN is presented in FIG. 2.

In a case when UE enters into a new cell and at the same time also the location area/routing area is changed, the UE starts the normal procedures to send MM: LOCATION UPDATE/ ROUTING AREA UPDATE messages to the CN. In this case if the multicast area also changes, the UE includes in the RRC: UPLINK DIRECT TRANSFER message the required information fields in order to indicate about multicast services. Based on received DTAP message, the new RNC includes into RANAP: DIRECT TRANSFER message required information fields, based on which CN is capable of sending RANAP(/RNSAP): MULTICAST SUBSCRIBER UPDATE message to the old RNC, which further is capable of deleting the invalid information from its database.

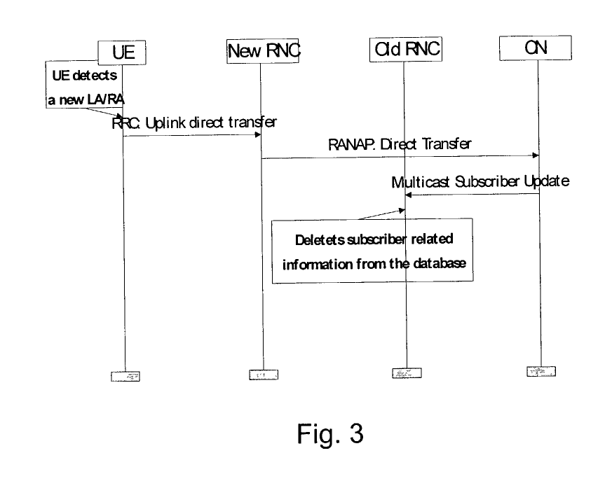

Another alternative is that when new RNC receives the RRC: UPLINK DIRECT TRANSFER message with multicast related information fields, the new RNC generates RNSAP: MULTICAST SUBSCRIBER UPDATE message, based on which the old RNC can delete the invalid information from its database. The example procedure is described in FIG. 3

7. Requesting of Multicast Status from RNC

When CN is preparing to start multicasting (or just likes to know the multicast status) for certain areas, certain groups/services or multicast subscribers (e.g. one or more Multicast areas), it can request the multicast status from RNCs with Multicast status procedure.

With MULTICAST STATUS REQUEST message CN can requests RNC to provide the current multicast status inside one multicast area (i.e. in one RNC). CN can request the following multicast status information from RNC:

a) multicast group/service status information.

b) multicast group/service status with multicast subscriber information.

c) multicast subscriber status information.

d) General multicast status information.

RNC uses the MULTICAST STATUS RESPONSE message to provide the current multicast status to CN. If just Multicast status information IE is included in the MULTICAST STATUS REQUEST message RNC provides both multicast group/service and multicast subscriber information to CN.

8. Message Structures for RRC, RNSAP and RANAP Messages

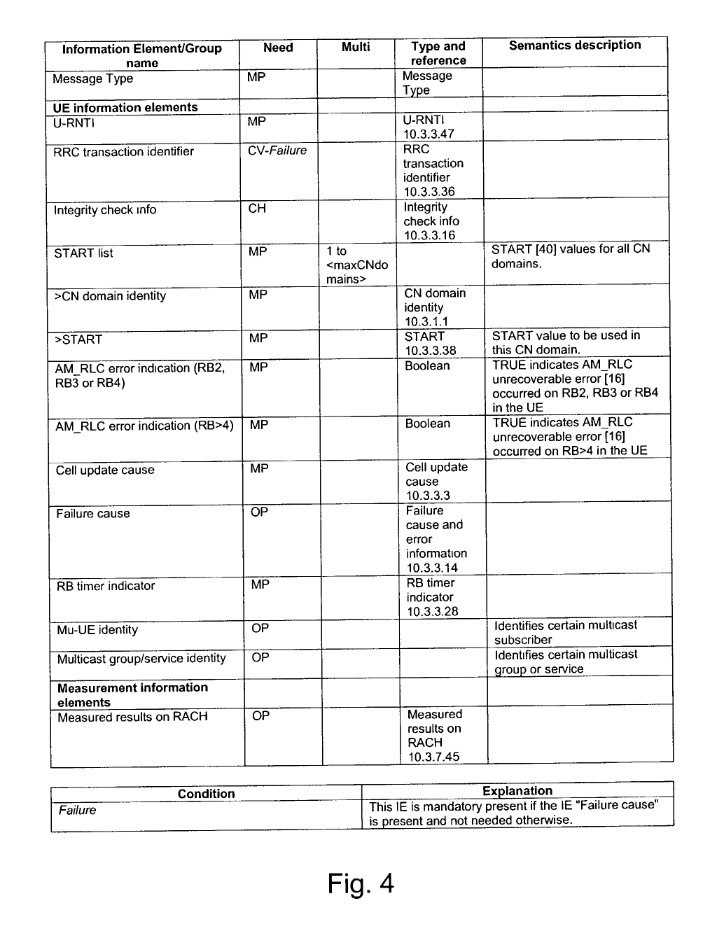

The RRC, RNSAP and RANAP messages are preferably adapted and updated from those already known in the 3GPP specification. Preferred formats and structures for the messages are illustrated in FIGS. 4-12 and described below. However, the messages can have formats and structures other than those illustrated and described herein.

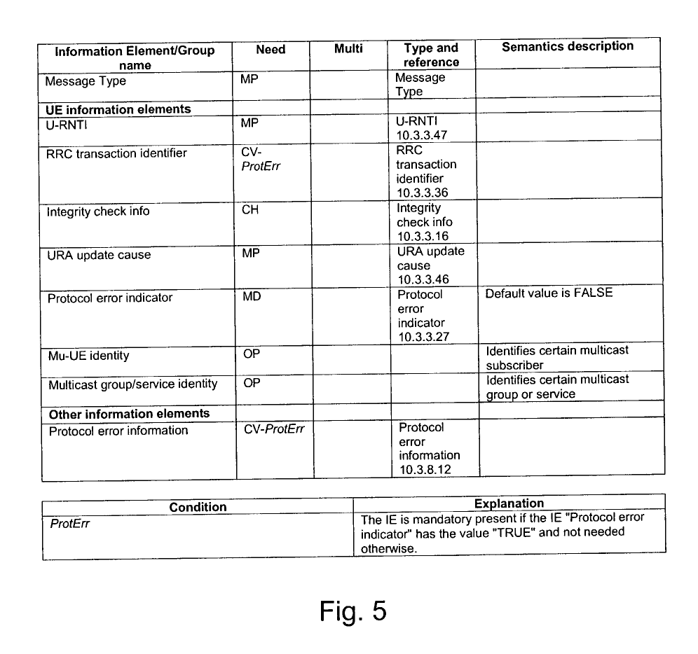

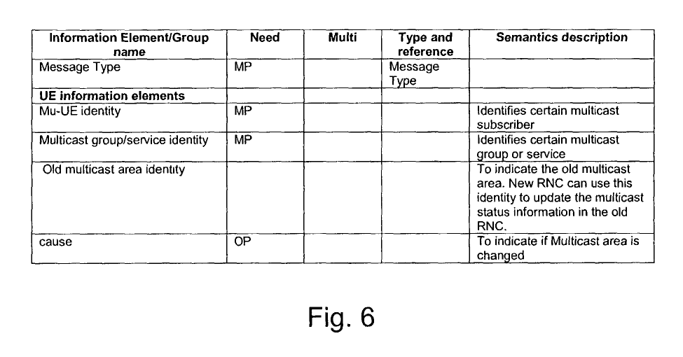

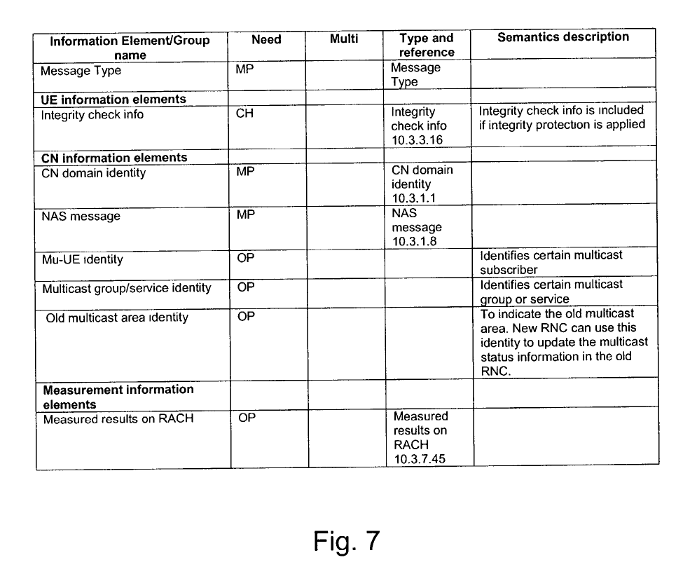

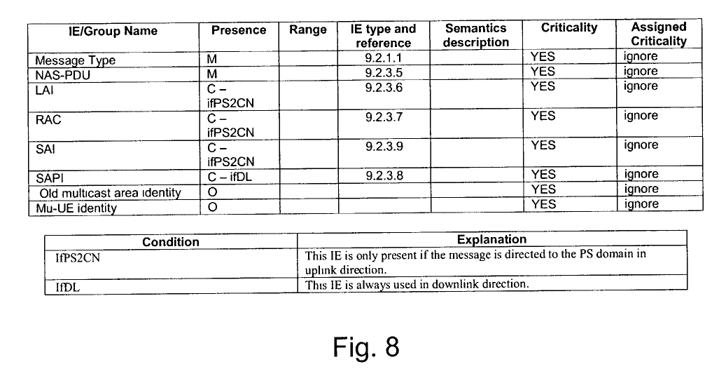

FIG. 4 illustrates the CELL UPDATE message according to the preferred embodiments, which is preferably adapted and updated from the currently specified CELL UPDATE message. FIG. 5 illustrates the URA UPDATE message according to the preferred embodiments, which is preferably adapted and updated from the currently specified URA UPDATE message. FIG. 6 illustrates the MULTICAST AREA UPDATE message according to the preferred embodiments. FIG. 7 illustrates the UPLINK DIRECT TRANSFER message according to the preferred embodiments, which is preferably adapted and updated from the currently specified UPLINK DIRECT TRANSFER message. FIG. 8 illustrates the DIRECT TRANSFER message sent by both the CN and the RNC to each other and is used for carrying NAS information over the lu interface in the preferred embodiments. It has a connection oriented signalling bearer mode and is adapted and updated from the currently specified DIRECT TRANSFER message.

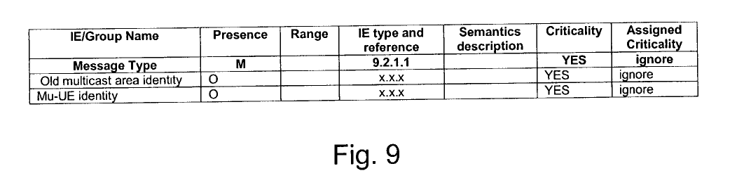

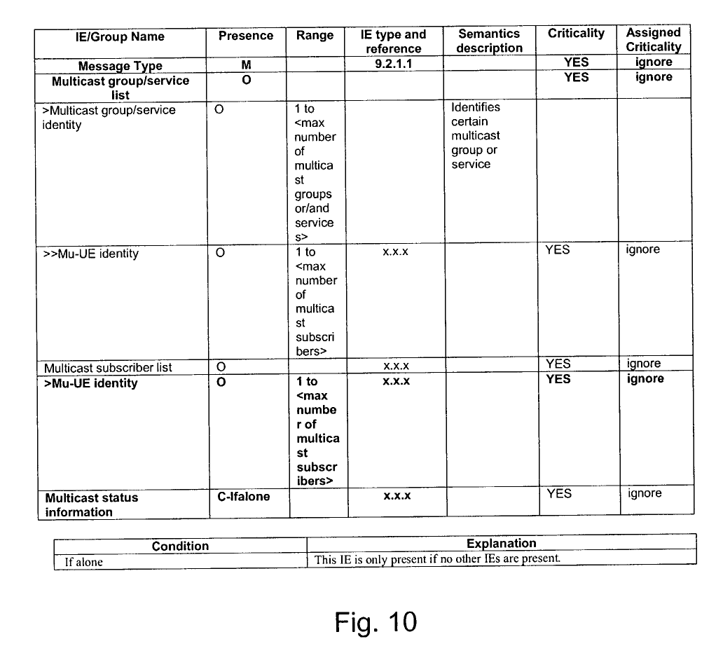

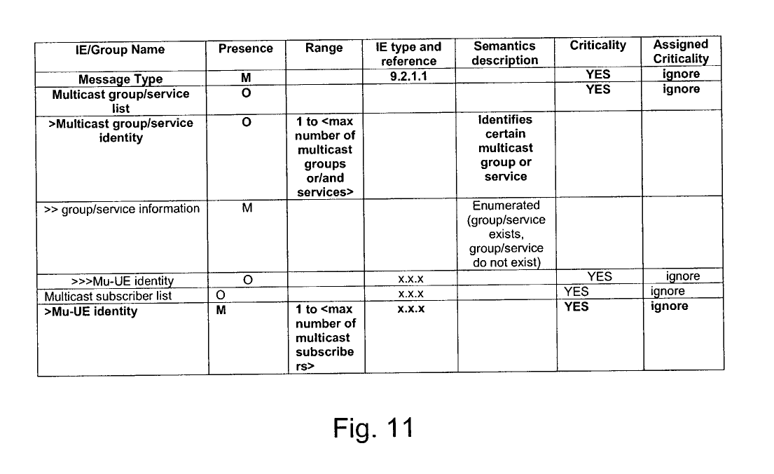

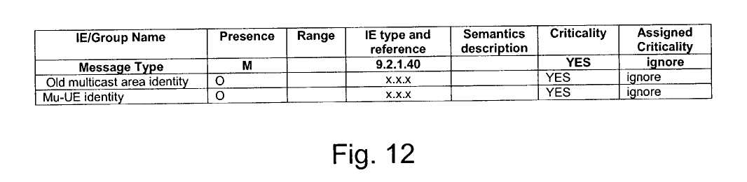

FIG. 9 illustrates the structure of the MULTICAST SUBSCRIBER UPDATE message sent by both the CN and the RNC to each other and is used for carrying multicast subscriber information over the lu interface in the preferred embodiments. It has a connection oriented or connectionless signalling bearer mode. FIG. 10 illustrates the structure of the MULTICAST SUBSCRIBER UPDATE message on RANAP sent by the CN to the RNC to request the status of multicast subscribers in RNC in the preferred embodiments. It has a connection oriented or connectionless signalling bearer mode. FIG. 11 illustrates the structure of the MULTICAST STATUS RESPONSE message on RANAP sent by the RNC to the CN to indicate the status of multicast subscriber in the RNC in the preferred embodiments. It has a connection oriented or connectionless signalling bearer mode. FIG. 12 illustrates the MULTICAST SUBSCRIBER UPDATE message on RNSAP sent between RNCs and is used for carrying multicast subscriber information over the lur interface in the preferred embodiments. It has a connection oriented or connectionless signalling bearer mode.

What is claimed is:

1. A method of keeping track of User equipment (UE) locations without regard to an existing Radio Resource Controller (RRC) connection for multicast services in a Routing Area Network (RAN), comprising the steps of:
performing a multicast area update procedure in the RRC whether the UE has an existing RRC connection or not,
wherein said performing step comprises:
sending from the UE a MULTICAST AREA UPDATE message when the UE detects whether a multicast area change has occurred.

2. A method according to claim 1, wherein said performing step further comprises the step:
detecting by the RNC whether the UE enters into a new cell, and if the UE is configured to receive multicast data, causing the UE to check priority of its multicast service subscription.

3. A method according to claim 2, wherein said detecting step further comprises the step of:
if the priority checked by the UE indicates the highest priority, sending by the UE to the network either a new Multicast location update message or the currently defined RRC.

4. A method according to claim 3, wherein the sending by the UE to the network step comprises the step of:
sending a Cell Update message to update support multicast related information, if the subscription of the multicast service is critical.

5. A method according to claim 3, wherein the sending by the UE to the network step comprises the step of:
not sending a Cell Update message to update support multicast related information, if the subscription of the multicast service is not critical.

6. A method of keeping track of User equipment (UE) locations without regard to an existing Radio Resource Controller (RRC) connection for multicast services in a Routing Area Network (RAN), comprising the steps of:
performing a multicast area update procedure in the RRC when the UE has an existing RRC connection,
wherein said performing step comprises:
sending from the UE a MULTICAST AREA UPDATE message when the UE detects whether a multicast area change has occurred.

7. A method according to claim 6, wherein said performing step further comprises the step:
detecting by the RNC whether the UE enters into a new cell, and if the UE is configured to receive multicast data, causing the UE to check priority of its multicast service subscription.

8. A method according to claim 7, wherein said detecting step further comprises the step of:
if the priority checked by the UE indicates the highest priority, sending by the UE to the network either a new Multicast location update message or the currently defined RRC.

9. A method according to claim 8, wherein the sending by the UE to the network step comprises the step of:
sending a Cell Update message to update support multicast related information, if the subscription of the multicast service is critical.

10. A method according to claim 8, wherein the sending by the UE to the network step comprises the step of:
not sending a Cell Update message to update support multicast related information, if the subscription of the multicast service is not critical.

11. A radio network controller (RNC) in a wireless communications network, said radio network controller carrying out a method of keeping track of User Equipment (UE) locations without regard to an existing Radio Resource Controller (RRC) connection for multicast services in a Routing Area Network (RAN), comprising the steps of:
performing a multicast area update procedure in the RRC whether the UE has an existing RRC connection or not,
wherein said performing step comprises:
receiving from the UE a MULTICAST AREA UPDATE message when the UE detects whether a multicast area change has occurred.

12. A radio network controller according to claim 11, wherein said performing step further comprises the step:
detecting whether the UE enters into a new cell, and if the UE is configured to receive multicast data, causing the UE to check priority of its multicast service subscription.

13. A radio network controller according to claim 12, wherein said detecting step further comprises the step of:
if the priority checked by the UE indicates the highest priority, receiving either a new Multicast Location Update message or the currently defined RRC.

14. A radio network controller according to claim 13, wherein the receiving step comprises the step of:
receiving a Cell Update message to update multicast related information, if the subscription of the multicast service is critical.

15. A radio network controller (RNC) in a wireless communications network, said radio network controller carrying out a method of keeping track of User Equipment (UE) locations without regard to an existing Radio Resource Controller (RRC) connection for multicast services in a Routing Area Network (RAN), comprising the steps of:
performing a multicast area update procedure in the RRC when the UE has an existing RRC connection,
wherein said performing step comprises:
receiving from the UE a MULTICAST AREA UPDATE message when the UE detects whether a multicast area change has occurred

16. A radio network controller according to claim 15, wherein said performing step further comprises the step:
detecting whether the UE enters into a new cell, and if the UE is configured to receive multicast data, causing the UE to check priority of its multicast service subscription.

17. A radio network controller according to claim 16, wherein said detecting step further comprises the step of:
if the priority checked by the UE indicates the highest priority, receiving either a new Multicast Location Update message or the currently defined RRC.

18. A radio network controller according to claim 17, wherein the receiving step comprises the step of:
receiving a Cell Update message to update multicast related information, if the subscription of the multicast service is critical.
